(19) United States
(12) Patent Application Publication
(10) Pub. No.: US 2007/0272881 A1
(43) Pub. Date: Nov. 29, 2007

(54) Optically coupled semiconductor device and electronic device

(75) Inventor: Yasushi Hasegawa, Nara (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/714,115

(22) Filed: Mar. 6, 2007

(30) Foreign Application Priority Data
May 29, 2006 (JP) 2006-148444

(51) Int. Cl. G02B 27/00

(52) U.S. Cl. 250/551

(57) ABSTRACT

In an embodiment of an optically coupled semiconductor device of the present invention, the optically coupled semiconductor device is provided with a resin sealing portion and lead drawing portions. The resin sealing portion integrally seals a power control semiconductor element chip, an firing light-receiving element chip for firing the power control semiconductor element chip, and a light-emitting element chip optically coupled with the firing light-receiving element, for converting an electric signal into an optical signal. The lead drawing portions are connected to the power control semiconductor element chip, the firing light-receiving element, and the light-emitting element chip, and are drawn out of the resin sealing portion. The optically coupled semiconductor device is further provided with a U-shaped radiator having extended portions that extend in an extending direction intersecting a drawing direction of the lead drawing portions and that are operable to hold the resin sealing portion therebetween.

This application claims priority under 35 U.S.C. § 119(a) on Patent Application No. 2006-148444 filed in Japan on May 29, 2006, the entire contents of which are hereby incorporated by reference.

### BACKGROUND OF THE INVENTION

1. Field of the Invention

The present invention relates to an optically coupled semiconductor device applied to a solid state relay and the like, and an electronic device in which the optically coupled semiconductor device is installed.

2. Description of the Related Art

An example of a conventional optically coupled semiconductor device is described with reference to FIG. 15. FIG. 15 is a side view showing a conventional optically coupled semiconductor device.

A conventional optically coupled semiconductor device 101 is configured, for example, as a solid state relay. In the solid state relay, a power control semiconductor element chip, a light-emitting element, and a firing light-receiving element are integrally sealed with a resin sealing portion 116. The power control semiconductor element chip is disposed on the secondary side, and drives loads such as a motor. The light-emitting element is disposed on the primary side, and converts an electric signal into an optical signal. The firing light-receiving element is disposed on the secondary side, and fires the power control semiconductor element chip, on receiving an optical signal from the light-emitting element optically coupled therewith.

In the optically coupled semiconductor device 101, a large effective current flows to the power control semiconductor element chip, in order to drive the loads. Thus, the amount of heat generated is large, so that the temperature at junction portions is increased. When the optically coupled semiconductor device 101 is left without taking any measure, the properties are deteriorated, and the reliability is lowered.

In order to address an increase in the temperature described above, in the conventional optically coupled semiconductor device 101, a radiator 121 serving as means for dissipating heat is in close contact via an adhesive layer 124 with the outer portion of the resin sealing portion 116. The radiator 121 that is disposed on one face of the resin sealing portion 116 dissipates heat only via an air layer, because the conventional optically coupled semiconductor device 101 is provided with lead drawing portions, for example, in the form of DIP (dual inline package), the lead drawing portions being drawn to the outside for mounting on a mounting board.

Furthermore, the radiator 121 is open upward (or downward), and thus its resistance against a force in the direction indicated by the arrow F is small. Thus, there is a problem in that the radiator 121 lacks reliability, for example, due to a possibility of falling off the resin sealing portion 116.

In the case of SIP (single inline package), as the means for dissipating heat, a radiator is screwed to a through-hole that is provided in advance in a resin sealing portion.

In addition to the above, semiconductor devices provided with radiators are described in Japanese Patent No. 2797978, Japanese Patent No. 3173149, JP H4-20245U, and JP H5-21451U. However, these radiators have complicated configurations, and cannot be easily attached. Even when the radiators can be easily attached, there is a problem in the attachment strength.

FIG. 16 is a graph of derating characteristics showing the relationship between the effective current IT that can flow to a power control semiconductor element chip, and the ambient temperature Ta.

The horizontal axis shows the ambient temperature Ta (° C.), and the vertical axis shows the effective current IT (A). In the case of the optically coupled semiconductor device 101 applied to a solid state relay, a larger effective current provides a wider application range, and thus there is a demand that an effective current that is as large as possible be allowed to flow. Furthermore, the broken line in FIG. 16 indicates the relationship between the effective current IT and the ambient temperature Ta of the power control semiconductor element in the conventional optically coupled semiconductor device.

More specifically, the effective current IT that can flow within an operating temperature range of the power control semiconductor element chip shows the derating characteristics indicated by the broken line in FIG. 16, depending on a thermal resistance Rth (j-a) of the package (the resin sealing portion 116) of the optically coupled semiconductor device 101. Accordingly, in a state where the ambient temperature Ta exceeds a predetermined temperature Tap, the effective current IT is lowered as the temperature increases, and the effective current IT substantially cannot flow at a temperature Tam. Thus, a large effective current IT cannot flow on the higher temperature side.

In order to allow a large effective current IT to flow on the higher temperature side, it is necessary to shift the temperature Tap at which a decrease in the effective current IT starts, toward the higher temperature side, by reducing the thermal resistance Rth (j-a) of the package, thereby improving heat dissipation.

However, in the conventional optically coupled semiconductor device, a radiator or heat dissipating terminal is separately and independently formed, and thus high heat dissipation cannot be realized. In other words, the derating characteristics are as indicated by the broken line in FIG. 16, and thus a large effective current cannot flow on the higher temperature side.

Furthermore, in a configuration where a lead frame is extended, or a radiator is exposed on a side face of the package, it is necessary to use a large number of special materials and equipment in production processes, and thus the cost increases.

### SUMMARY OF THE INVENTION

The present invention has been made in view of these circumstances, and it is an object thereof to provide an optically coupled semiconductor device in which an effective current larger than that in conventional examples can flow on the higher temperature side because the derating characteristics of the effective current with respect to the ambient temperature have been improved by devising the configuration of means for dissipating heat so as to improve heat dissipation, and an electronic device in which the optically coupled semiconductor device is installed.

The present invention is directed to an optically coupled semiconductor device that is provided with a resin sealing portion and lead drawing portions, the resin sealing portion integrally sealing a power control semiconductor element chip, an firing light-receiving element chip for firing the power control semiconductor element chip, and a light-emitting element chip optically coupled with the firing light-receiving element, for converting an electric signal into an optical signal, and the lead drawing portions being connected to the power control semiconductor element chip, the firing light-receiving element, and the light-emitting element chip, and being drawn out of the resin sealing portion, comprising: a U-shaped radiator having extended portions that extend in an extending direction intersecting a drawing direction of the lead drawing portions and that are operable to hold the resin sealing portion therebetween.

With this configuration, both the upper and lower faces of the resin sealing portion are held by the extended portions of the U-shaped radiator, and thus the area in which heat is dissipated from the resin sealing portion is increased. Accordingly, the heat dissipation properties are improved, and thus an effective current at a high temperature can be increased, so that an optically coupled semiconductor device with a high reliability is obtained. Furthermore, the U-shaped radiator is formed into a simple shape that does not fall off the resin sealing portion, and thus production failures can be reduced in the production processes or while it is mounted. Thus, a low cost optically coupled semiconductor device with a good productivity is obtained.

Furthermore, in the optically coupled semiconductor device according to the present invention, a groove portion is formed on an inner face of the extended portions.

With this configuration, an adhesive layer with a sufficient thickness corresponding to the depth of the groove potion can be ensured between the U-shaped radiator and the resin sealing portion. Thus, the adhesive strength of the U-shaped radiator with respect to the resin sealing portion can be improved, so that the heat dissipation properties and the reliability can be improved.

Furthermore, in the optically coupled semiconductor device according to the present invention, the groove portion is formed in a direction intersecting the extending direction.

With this configuration, the thickness of the adhesive layer can be made uniform. Accordingly, it is possible to reduce unevenness in the heat dissipation properties, and thus an optically coupled semiconductor device with a high reliability is obtained.

Furthermore, in the optically coupled semiconductor device according to the present invention, outward protrusions are formed by bending ends of the extended portions outward.

With this configuration, the resin sealing portion can be easily inserted into the U-shaped radiator, and thus engagement can be easily performed.

Furthermore, in the optically coupled semiconductor device according to the present invention, the extended portions are formed such that an opposing distance therebetween is short on the side of ends.

With this configuration, the ends of the extended portions are in pressure contact with the resin sealing portion. Thus, the holding force is improved, so that the engagement strength can be improved.

Furthermore, in the optically coupled semiconductor device according to the present invention, the outward protrusions are formed such that outer contact faces defined by the extended portions and the outward protrusions are in parallel with the resin sealing portion.

With this configuration, it is possible to prevent the outer contact faces from being inclined with respect to the resin sealing portion. Thus, an optically coupled semiconductor device is obtained in which the resin sealing portion can be mounted on the mounting board in parallel therewith.

Furthermore, in the optically coupled semiconductor device according to the present invention, inward protrusions are formed by bending ends of the extended portions inward.

With this configuration, it is possible to completely prevent the U-shaped radiator from falling off the resin sealing portion, and thus the adhesive layer can be made thin.

Furthermore, in the optically coupled semiconductor device according to the present invention, a linking portion for linking between the extended portions is bent.

With this configuration, the spring properties of the U-shaped radiator (extended portions) can be improved. Thus, the contact of the U-shaped radiator with the resin sealing portion can be improved, so that the heat dissipation properties can be improved.

Furthermore, in the optically coupled semiconductor device according to the present invention, the extended portions have a cut-out portion formed by selectively removing a portion corresponding to the lead drawing portion that is drawn out of the resin sealing portion.

With this configuration, it is possible to ensure the creepage distance for preventing electric discharge between the U-shaped radiator and the lead drawing portion that is drawn out of the resin sealing portion. Accordingly, an optically coupled semiconductor device causing no electric discharge and thus having a high reliability is improved.

Furthermore, in the optically coupled semiconductor device according to the present invention, the extended portions have holding portions for selectively holding the lead drawing portion that is drawn out of the resin sealing portion.

With this configuration, the U-shaped radiator can be linked to the lead drawing portion provided with the chip that particularly requires heat dissipation in the lead drawing portion that is drawn out of the resin sealing portion. Thus, the heat dissipation properties are further improved, so that an optically coupled semiconductor device with a high reliability is obtained.

Furthermore, in the optically coupled semiconductor device according to the present invention, the holding portions hold therebetween a lead drawing portion of a lead frame on which the power control semiconductor element chip is mounted.

With this configuration, the heat dissipation of the power control semiconductor element chip can be improved. Thus, an optically coupled semiconductor device is obtained in which a large amount of electrical power can be supplied even at a high temperature.

Furthermore, in the optically coupled semiconductor device according to the present invention, the extended portion disposed closer to a mounting board is longer than the other extended portion.

With this configuration, the area abutting against the mounting board can be increased, and thus an optically coupled semiconductor device is obtained in which the heat dissipation properties toward the mounting board are improved.

Furthermore, the present invention is directed to an electronic device in which an optically coupled semiconductor device is mounted on a mounting board, wherein the optically coupled semiconductor device is the optically coupled semiconductor device according to the present invention.

With this configuration, an effective current at a high temperature can be increased, and thus an electronic device with a high reliability is obtained.

Furthermore, in the optically coupled semiconductor device according to the present invention, the extended portion disposed closer to the mounting board is in contact with the mounting board.

With this configuration, heat is conducted directly from the U-shaped radiator to the mounting board without passing through space. Thus, heat dissipation to the mounting board can be ensured, so that the heat dissipation properties can be further improved.

### BRIEF DESCRIPTION OF THE DRAWINGS

FIG. 1A is a see-through plan view illustrating the outline of an optically coupled semiconductor device according to Embodiment 1 of the present invention excluding a U-shaped radiator, showing a plane with a power control semiconductor element from the side of a light-emitting element chip.

FIG. 1B is a see-through side view showing the main portions on a cross section of FIG. 1A, viewed in the direction indicated by the arrow B.

FIG. 2A is a plan view showing the optically coupled semiconductor device according to Embodiment 1 of the present invention.

FIG. 2B is a side view of FIG. 2A, viewed in the direction indicated by the arrow B.

FIG. 3A is a plan view showing an optically coupled semiconductor device according to Embodiment 2 of the present invention.

FIG. 3B is a side view of FIG. 3A, viewed in the direction indicated by the arrow B.

FIG. 4A is a plan view showing an optically coupled semiconductor device according to modified Embodiment 2 of the present invention.

FIG. 4B is a side view of FIG. 4A, viewed in the direction indicated by the arrow B.

FIG. 5 is a side view showing an unengaged U-shaped radiator for holding a resin sealing portion of an optically coupled semiconductor device according to Embodiment 3 of the present invention.

FIG. 6A is a side view showing a configuration example for improving the spring properties of the U-shaped radiator for holding the resin sealing portion of the optically coupled semiconductor device according to Embodiment 3 of the present invention, by linearly bending the linking portion to form a bent face.

FIG. 6B is a side view showing a configuration example for improving the spring properties of the U-shaped radiator for holding the resin sealing portion of the optically coupled semiconductor device according to Embodiment 3 of the present invention, by curvingly bending the linking portion to form a bent face.

FIG. 7A is a side view showing an unengaged U-shaped radiator for holding a resin sealing portion of an optically coupled semiconductor device according to Embodiment 4 of the present invention, as the main portions of the optically coupled semiconductor device.

FIG. 7B is a side view showing the U-shaped radiator engaged with the resin sealing portion, the view being an explanatory diagram similar to FIG. 7A.

FIG. 8 is a side view of an optically coupled semiconductor device according to Embodiment 5 of the present invention.

FIG. 9 is a plan view of an optically coupled semiconductor device according to Embodiment 6 of the present invention.

FIG. 10A is a process diagram illustrating a method for producing the U-shaped radiator for holding the resin sealing portion of the optically coupled semiconductor device according to Embodiment 6 of the present invention, the diagram being a plan view of a prepared long base material in a first cutting process.

FIG. 10B is a process diagram illustrating the method for producing the U-shaped radiator according to Embodiment 6 of the present invention, the diagram being a plan view of the prepared long base material in a second cutting process.

FIG. 10C is a process diagram illustrating the method for producing the U-shaped radiator according to Embodiment 6 of the present invention, the diagram being a plan view of symmetric U-shaped radiators obtained in the second cutting process.

FIG. 10D is a process diagram illustrating the method for producing the U-shaped radiator according to Embodiment 6 of the present invention, the diagram being a plan view of a plurality of formed U-shaped radiators.

FIG. 11A is a plan view of an optically coupled semiconductor device according to Embodiment 7 of the present invention.

FIG. 11B is a side view of FIG. 11A, viewed in the direction indicated by the arrow B.

FIG. 12A is a plan view of the optically coupled semiconductor device according to Embodiment 7 of the present invention.

FIG. 12B is a side view of FIG. 12A, viewed in the direction indicated by the arrow B.

FIG. 13A is a plan view of an optically coupled semiconductor device according to Embodiment 8 of the present invention.

FIG. 13B a side view of FIG. 13A, viewed in the direction indicated by the arrow B.

FIG. 14A is a process diagram illustrating a method for producing the U-shaped radiator for holding the resin sealing portion of the optically coupled semiconductor device according to Embodiment 8 of the present invention, the diagram being a plan view of a prepared long base material in a third cutting process.

FIG. 14B is a process diagram illustrating the method for producing the U-shaped radiator according to Embodiment 8 of the present invention, the diagram being a plan view of the prepared long base material in a fourth cutting process.

FIG. 14C is a process diagram illustrating the method for producing the U-shaped radiator according to Embodiment 8 of the present invention, the diagram being a side view of the U-shaped radiator obtained in the fourth cutting process.

FIG. 14D is a process diagram illustrating the method for producing the U-shaped radiator according to Embodiment 8 of the present invention, the diagram being a side view of the U-shaped radiator on which the holding portions are formed.

FIG. 14E is a process diagram illustrating the method for producing the U-shaped radiator according to Embodiment 8 of the present invention, the diagram being a plan view of the U-shaped radiator on which the holding portions are formed.

FIG. 15 is a side view showing a conventional optically coupled semiconductor device.

FIG. 16 is a graph of derating characteristics showing the relationship between the effective current IT that can flow to a power control semiconductor element chip, and the ambient temperature Ta.

### DESCRIPTION OF THE PREFERRED EMBODIMENTS

Hereinafter, embodiments of the present invention are described with reference to the drawings.

### Embodiment 1

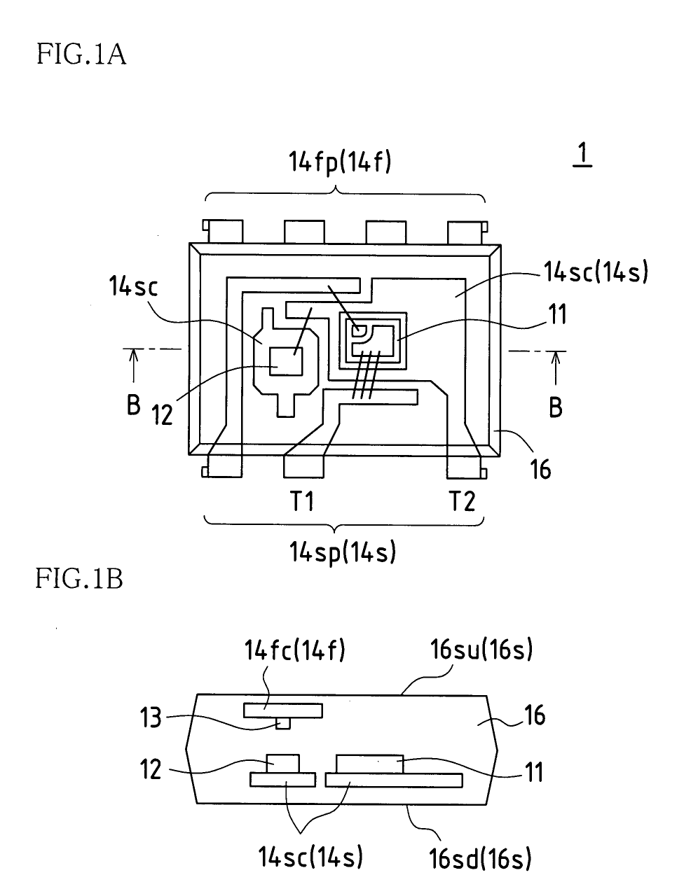

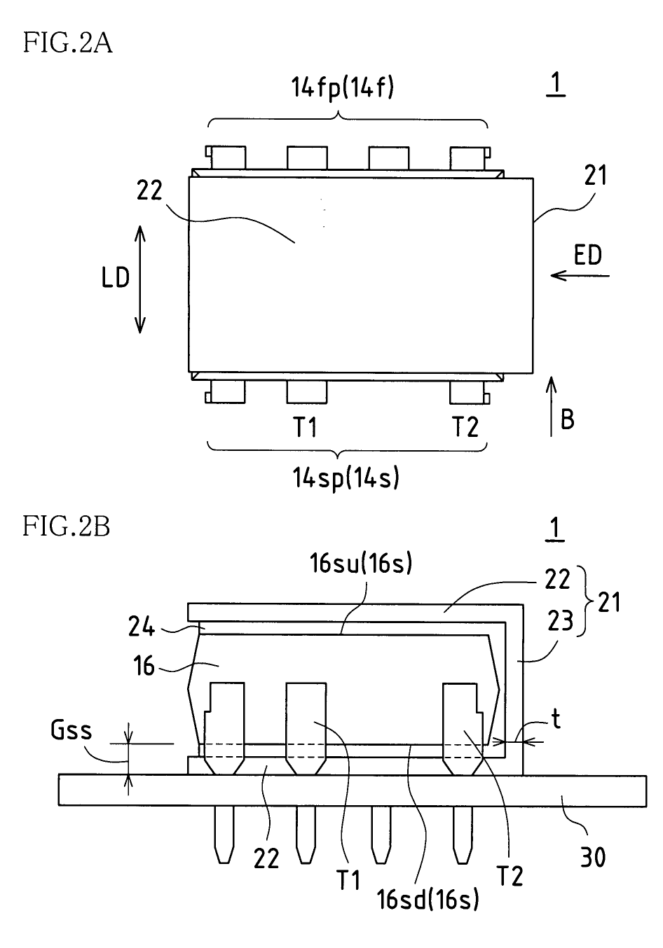

An optically coupled semiconductor device according to Embodiment 1 of the present invention is described with reference to FIGS. 1A, 1B, 2A, and 2B.

FIG. 1A is a see-through plan view illustrating the outline of an optically coupled semiconductor device according to Embodiment 1 of the present invention before a U-shaped radiator is engaged therewith, showing a plane with a power control semiconductor element from the side of a light-emitting element chip. FIG. 1B is a see-through side view showing the main portions on a cross section of FIG. 1A, viewed in the direction indicated by the arrow B. In FIG. 1B, hatching has been omitted.

An optically coupled semiconductor device 1 has a primary-side lead frame 14f and a secondary-side lead frame 14s that are opposed to each other. On the inner side on the secondary-side lead frame 14s, a plurality of chip mounting portions 14sc are formed that are substantially on the same plane. A power control semiconductor element chip 11 and an firing light-receiving element chip 12 for firing the power control semiconductor element chip 11 are separately mounted on the respective chip mounting portions 14sc. As the power control semiconductor element chip 11, a triac element chip or a thyristor element chip may be used. On the inner side on the primary-side lead frame 14f, a chip mounting portion 14fc is formed on which a light-emitting element chip 13 is mounted. The light-emitting element chip 13 converts an electric signal into an optical signal, and is optically coupled with the firing light-receiving element chip 12.

The power control semiconductor element chip 11, the firing light-receiving element chip 12, and the light-emitting element chip 13 are electrically connected as appropriate to each other via wires, and are integrally sealed with a resin sealing portion 16. Lead drawing portions 14fp and 14sp connected as appropriate to the power control semiconductor element chip 11, the firing light-receiving element chip 12, and the light-emitting element chip 13 are opposed to each other and drawn out of the resin sealing portion 16. Thus, the optically coupled semiconductor device 1 is sealed with a resin in the form of DIP (dual inline package).

Furthermore, the lead drawing portions 14fp and 14sp are bent in the direction intersecting an upper surface 16su and a lower surface 16sd of the resin sealing portion 16 such that mounting onto (insertion into) a mounting board 30 (see FIG. 2B), which is described later, can be easily performed. The terms “upper” and “lower” of the upper surface 16su and the lower surface 16sd indicate the relative positional relationship, and the surface closer to the mounting board 30 is taken as the lower surface 16sd. In a case where it is not necessary to distinguish between the upper surface 16su and the lower surface 16sd, the surfaces are simply referred to as sealing portion surfaces 16s.

The chip mounting portion 14sc on which the power control semiconductor element chip 11 is mounted is drawn out as an 8^{th} pin (second output terminal T2) of output terminals (terminals on the secondary side). The other terminal of the power control semiconductor element chip 11 is drawn out as a 6^{th} pin (first output terminal T1).

FIG. 2A is a plan view showing the optically coupled semiconductor device according to Embodiment 1 of the present invention. FIG. 2B is a side view of FIG. 2A, viewed in the direction indicated by the arrow B. In FIG. 2B, the optically coupled semiconductor device is mounted on the mounting board 30 of an electronic device (not shown).

The optically coupled semiconductor device 1 according to this embodiment is provided with a U-shaped radiator 21 having extended portions 22 that extend in an extending direction ED intersecting a drawing direction LD of the lead drawing portions 14fp and 14sp and that hold the resin sealing portion 16 from both the upper and lower faces thereof.

The U-shaped radiator 21 has two extended portions 22 that are in the shape of flat plates opposed to each other, and a linking portion 23 that links between the two extended portions 22. The extended portions 22 abut against (are engaged with) (the upper surface 16su and the lower surface 16sd of) the resin sealing portion 16. Accordingly, an opening is formed by the extended portions 22 on the side opposite to the linking portion 23, and the resin sealing portion 16 can be inserted from the opening toward the inside of the U-shaped radiator 21. More specifically, the direction opposite to the extending direction ED is an insertion direction of the resin sealing portion 16 to the U-shaped radiator 21.

The U-shaped radiator 21 can be easily formed, for example, by performing extrusion-molding or sheet-processing on metals such as aluminum, copper or iron, or resins having good thermal conduction.

The resin sealing portion 16 and the U-shaped radiator 21 are secured to (engaged with) each other, by being bonded via an adhesive layer 24 that is constituted by a silicone adhesive or the like for dissipating heat. More specifically, after the silicone adhesive or the like for dissipating heat is applied to the sealing portion surfaces 16s or the inner faces of the U-shaped radiator 21, the resin sealing portion 16 is inserted from the side of the second output terminal T2 through the opening of the U-shaped radiator 21, and placed such that the resin sealing portion 16 abuts against the inner face of the linking portion 23 via the adhesive layer 24.

Thus, according to the optically coupled semiconductor device 1, both the upper and lower faces of the resin sealing portion 16 are held by the extended portions 22 of the U-shaped radiator 21, so that heat is dissipated from both the sealing portion surfaces 16s of the resin sealing portion 16, and thus the area in which heat is dissipated from the resin sealing portion 16 is substantially increased. Accordingly, heat dissipation from the resin sealing portion 16 can be improved, and thus an effective current at a high temperature can be increased, so that the reliability can be improved.

Herein, the thickness of the extended portions 22 is the same as or larger than a stand-off Gss of the optically coupled semiconductor device 1 (spacing between the mounting board 30 and the lower surface 16sd). With this thickness, when the optically coupled semiconductor device 1 is mounted on the mounting board 30, the U-shaped radiator 21 is ensured to be in contact with the surface of the mounting board 30. More specifically, heat can be dissipated from the U-shaped radiator 21 to the mounting board 30 without passing through an air layer, and significantly higher heat dissipation can be ensured compared with a case in which means for dissipating heat is provided only on the upper surface 16su. Thus, heat can be more effectively dissipated.

In consideration of the thickness of the mounting board 30, and the length of the lead drawing portions 14fp and 14sp in the thickness direction of the mounting board 30, the upper limit of the thickness of the extended portions 22 is determined such that connection (for example, soldering) to the mounting board 30 is possible. In the case of the through-hole form in which connection is established by inserting the lead drawing portions 14fp and 14sp into the mounting board 30, it is determined such that the ends of the lead drawing portions 14fp and 14sp project from the rear face of the mounting board 30.

As described above, according to this embodiment, since the U-shaped radiator 21 has the shape of a U that is formed by the extended portions 22 and the linking portion 23, the heat dissipation effect from the bottom face (the lower surface 16sd) of the optically coupled semiconductor device 1 can be improved, and heat diffused via an air layer to the upper face can be efficiently dispersed to the mounting board 30. Thus, the optically coupled semiconductor device 1 can be obtained in which a large effective current IT can flow at a high temperature.

Furthermore, since the secondary-side lead frame 14s connected to the power control semiconductor element chip 11 is disposed on the side of the lower surface 16sd, the thermal resistance Rth (j-a) of the resin sealing portion 16 can be reliably reduced, and thus effective heat dissipation can be realized, so that a larger effective current IT can flow.

Furthermore, since the U-shaped radiator 21 holds the resin sealing portion 16, the securing strength (engagement strength) of the U-shaped radiator 21 with respect to the resin sealing portion 16 is improved. Accordingly, compared with a case in which means for dissipating heat is provided only one face as in conventional examples, the U-shaped radiator 21 does not fall off in production processes or while it is mounted on the mounting board 30, and thus a stable productivity can be ensured.

It should be noted that in a case where the amount of heat generated from the power control semiconductor element chip 11 and the like is large, the heat dissipation effect can be further improved by increasing a thickness t of the linking portion 23, thereby increasing the heat dissipation capacity of the U-shaped radiator 21.

### Embodiment 2

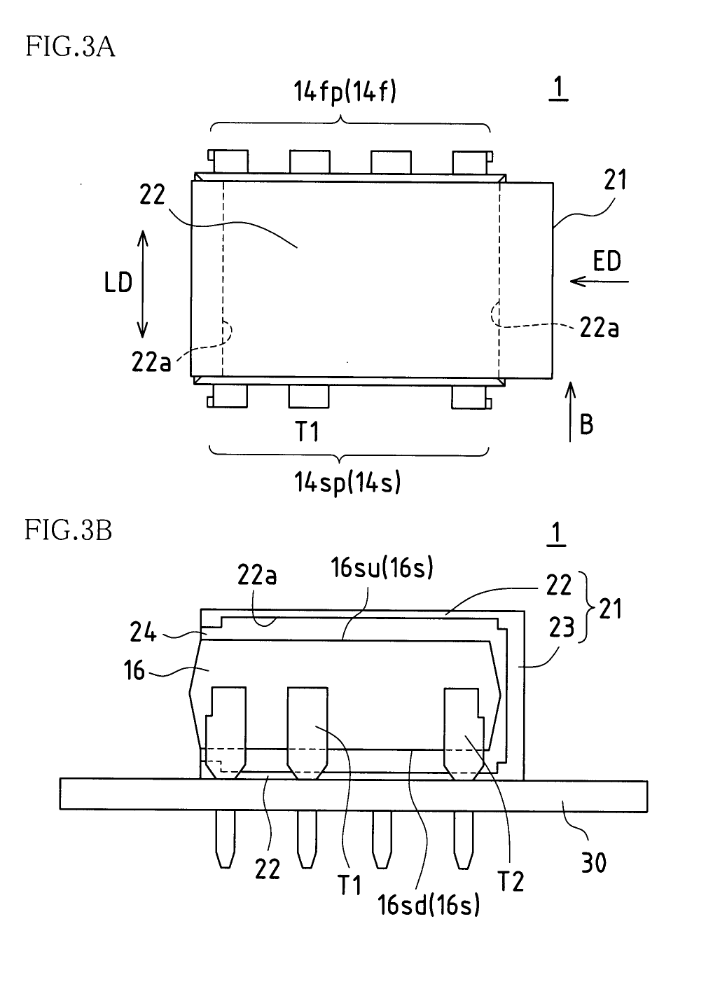

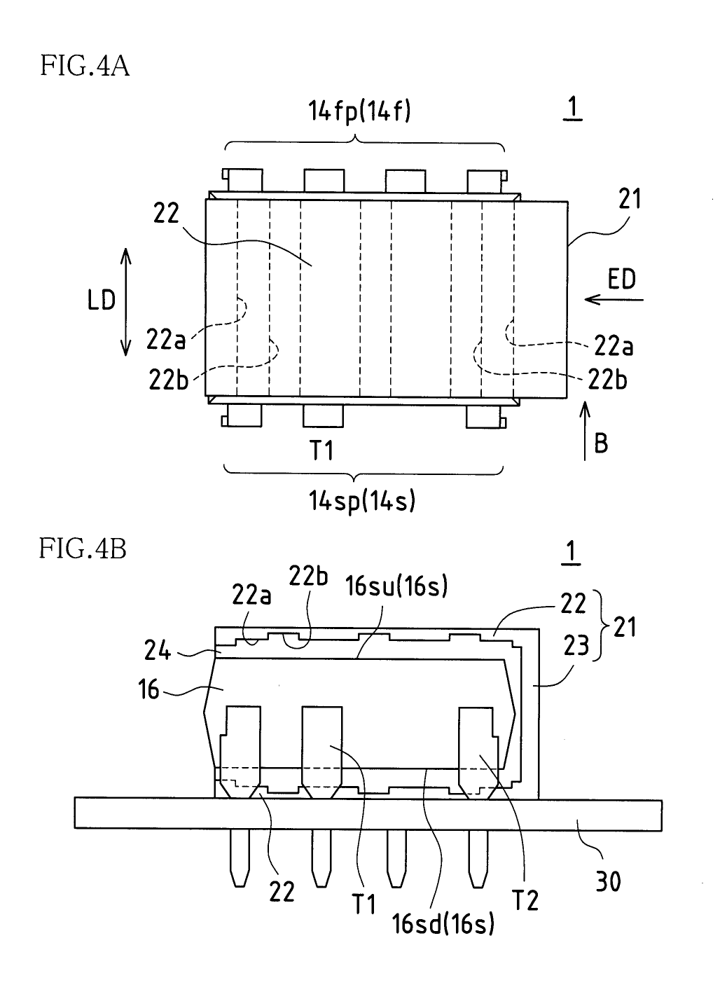

An optically coupled semiconductor device according to Embodiment 2 of the present invention is described with reference to FIGS. 3A, 3B, 4A, and 4B.

FIG. 3A is a plan view showing an optically coupled semiconductor device according to Embodiment 2 of the present invention. FIG. 3B is a side view of FIG. 3A, viewed in the direction indicated by the arrow B. In FIG. 3B, the optically coupled semiconductor device is mounted on the mounting board 30 of an electronic device (not shown).

In this embodiment, the shape of the U-shaped radiator 21 in Embodiment 1 has been modified. The other configurations are the same as those in Embodiment 1, and thus a description thereof has been omitted as appropriate.

In a case where the inner faces of the extended portions 22 are flat as in Embodiment 1, the U-shaped radiator 21 may be displaced upward or downward with respect to the resin sealing portion 16 due to spacing (clearance) between the U-shaped radiator 21 and the sealing portion surfaces 16s. In this case, the adhesive layer 24 on one side is extremely thin, and thus a sufficient adhesive strength may not be obtained. This embodiment is to address this problem.

More specifically, in this embodiment, groove portions 22a in the direction intersecting the extending direction ED are formed on the inner faces of the extended portions 22. When the groove portions 22a are provided on the inner faces of the U-shaped radiator 21, a sufficient thickness of the adhesive layer 24 corresponding to the depth of the groove portions 22a can be ensured. In other words, when an adhesive is applied to the U-shaped radiator 21, the adhesive is applied with a sufficient thickness, and thus a sufficient thickness of the adhesive layer 24 can be ensured for the U-shaped radiator 21 on both the upper side and the lower side of the resin sealing portion 16. It is preferable that the groove portions 22a are made symmetric at the upper side and the lower side of the resin sealing portion 16.

FIG. 4A is a plan view showing an optically coupled semiconductor device according to modified Embodiment 2 of the present invention. FIG. 4B is a side view of FIG. 4A, viewed in the direction indicated by the arrow B. In FIG. 4B, the optically coupled semiconductor device is mounted on the mounting board 30 of an electronic device (not shown).

In FIGS. 4A and 4B, grooves are superimposed on the grooves in FIGS. 3A and 3B. The other configurations are the same as those in FIGS. 3A and 3B, and thus a description thereof has been omitted as appropriate.

More specifically, the depth of the groove portions 22a in FIGS. 3A and 3B is uniform, but in FIGS. 4A and 4B, superimposed groove portions 22b in the direction intersecting the extending direction ED are formed such that the superimposed groove portions 22b are superimposed on the groove portions 22a. This configuration achieves similar action and effects to those in FIGS. 3A and 3B.

Furthermore, the groove portions 22a and 22b may have a shape other than rectangular shown in FIGS. 3A, 3B, 4A, and 4B, such as triangular or arc shape. In particular, in a case where vertices of a triangle or rectangle are rounded off, the flowability of an applied adhesive is improved, and thus the advantage is obtained that an air layer is hardly generated in the adhesive layer 24. It is preferable that the groove portions 22a and 22b are symmetric at the faces of the resin sealing portion 16, but this is not a limitation.

Since the groove portions 22a and 22b are arranged in the direction intersecting the extending direction ED (direction intersecting the element insertion direction), an adhesive can be prevented from being nonuniform by being pulled by the resin sealing portion 16 when the resin sealing portion 16 is inserted into the U-shaped radiator 21.

Furthermore, the groove portions 22a and 22b can be easily formed, for example, by extrusion-molding or cutting when producing the U-shaped radiator 21, and thus mass and stable production is possible.

### Embodiment 3

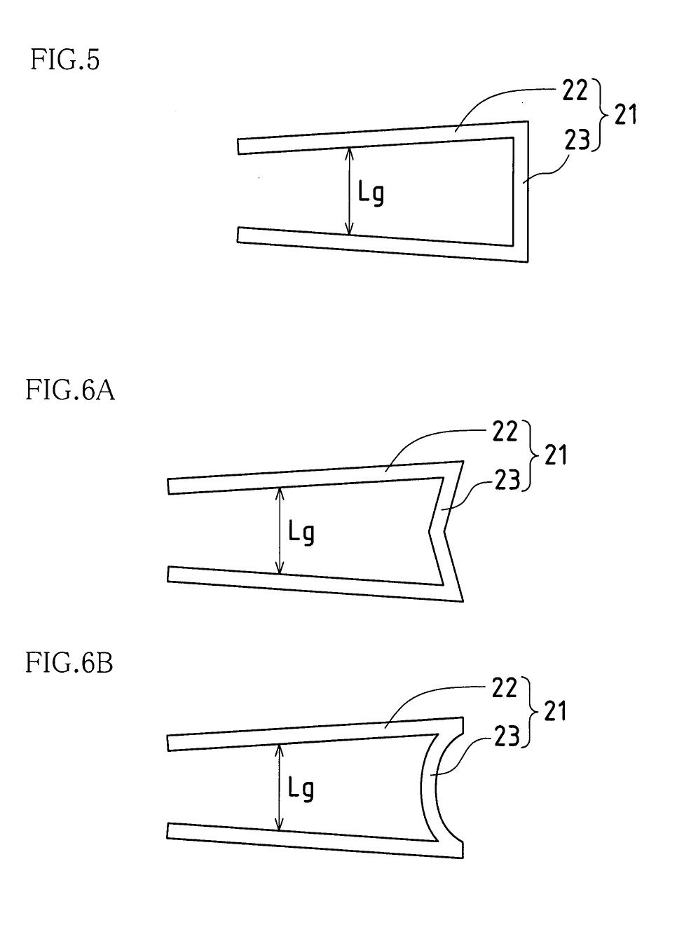

An optically coupled semiconductor device according to Embodiment 3 of the present invention is described with reference to FIGS. 5, 6A, and 6B.

FIG. 5 is a side view showing an unengaged U-shaped radiator for holding a resin sealing portion of an optically coupled semiconductor device according to Embodiment 3 of the present invention. In FIG. 5, the optically coupled semiconductor device 1 is not shown, but has the same configuration as those in the foregoing embodiments, and thus this embodiment is described referring to the reference numerals used in the embodiments as appropriate.

The U-shaped radiator 21 of the optically coupled semiconductor device 1 according to this embodiment has spring properties such that an opposing distance Lg between the extended portions 22 is long on the side of the linking portion 23 and is short on the side of the ends of the extended portions 22 in a state where the resin sealing portion 16 is not inserted. Accordingly, when the opposing distance Lg is at the same level as the thickness of the resin sealing portion 16 (length between the upper surface 16su and the lower surface 16sd) on the side of the linking portion 23 at which the opposing distance Lg is longest, the entire extended portions 22 are in pressure contact with the resin sealing portion 16, and thus the engagement strength can be further improved.

More specifically, since the extended portions 22 are in pressure contact with the resin sealing portion 16, the U-shaped radiator 21 can reliably hold the resin sealing portion 16. Furthermore, it is not necessary to form the adhesive layer 24 (see Embodiment 1, Embodiment 2, and modified Embodiment 2), and thus the production processes can be simplified.

FIG. 6A is a side view showing a configuration example for improving the spring properties of the U-shaped radiator for holding the resin sealing portion of the optically coupled semiconductor device according to Embodiment 3 of the present invention, by linearly bending the linking portion to form a bent face. FIG. 6B is a side view showing a configuration example for improving the spring properties of the U-shaped radiator for holding the resin sealing portion of the optically coupled semiconductor device according to Embodiment 3 of the present invention, by curvingly bending the linking portion to form a bent face. The U-shaped radiator 21 shown in FIGS. 6A and 6B is a modified example of the U-shaped radiator 21 in FIG. 5.

In FIG. 6A, a bent face is formed by linearly bending the middle portion of the linking portion 23, and spring properties are provided such that the opposing distance Lg between the extended portions 22 is long on the side of the linking portion 23 and is short on the side of the ends of the extended portions 22 in a state where the resin sealing portion 16 is not inserted. This configuration can improve the pressure contact effect compared with the case of FIG. 5, and achieves similar action and effects to those in FIG. 5.

In FIG. 6B, a bent face is formed by curvingly bending the middle portion of the linking portion 23, and spring properties are provided such that the opposing distance Lg between the extended portions 22 is long on the side of the linking portion 23 and is short on the side of the ends of the extended portions 22 in a state where the resin sealing portion 16 is not inserted. This configuration can improve the pressure contact effect compared with the case of FIG. 5, and achieves similar action and effects to those in FIG. 5.

It should be noted that this embodiment can be applied to other embodiments as appropriate.

### Embodiment 4

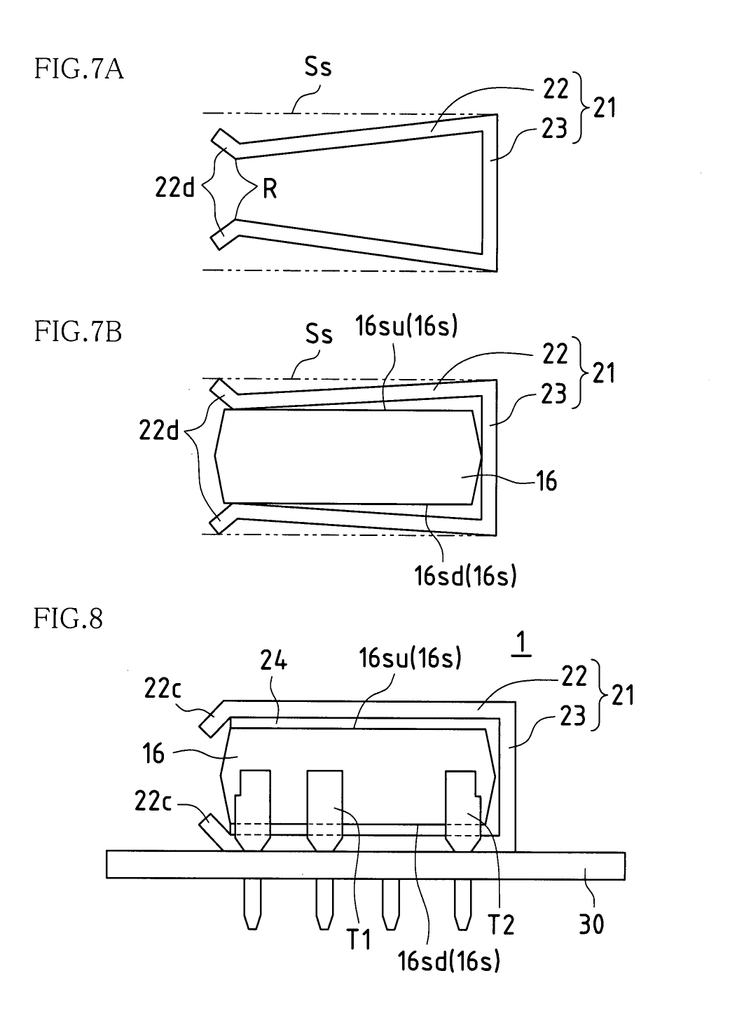

An optically coupled semiconductor device according to Embodiment 4 of the present invention is described with reference to FIGS. 7A and 7B.

FIG. 7A is a side view showing an unengaged U-shaped radiator for holding a resin sealing portion of an optically coupled semiconductor device according to Embodiment 4 of the present invention, as the main portions of the optically coupled semiconductor device. FIG. 7B is a side view showing the U-shaped radiator engaged with the resin sealing portion, the view being an explanatory diagram similar to FIG. 7A.

In the U-shaped radiator 21 of the optically coupled semiconductor device 1 according to this embodiment, outward protrusions 22d are formed by bending the ends of the extended portions 22 outward. Since the outward protrusions 22d are formed by bending the ends of the extended portions 22, the clamping positions are on the outer side, and small corners R are formed on the inner side. When the resin sealing portion 16 is inserted into the U-shaped radiator 21, this configuration can guide the resin sealing portion 16 to the U-shaped radiator 21. Thus, it is possible to reduce the operation burden during element insertion in the production processes.

It should be noted that although the outward protrusions 22d are herein formed by linearly bending the ends, it is also possible to form the entire outward protrusions 22d as bent faces.

The U-shaped radiator 21 in this embodiment has outer contact faces Ss defined by the extended portions 22 and the outward protrusions 22d. In a state where the U-shaped radiator 21 is engaged with the resin sealing portion 16, in order to mount the resin sealing portion 16 (optically coupled semiconductor device 1) on the mounting board 30 in parallel therewith, it is preferable to form the outer contact faces Ss in parallel with the resin sealing portion 16 (the sealing portion surfaces 16s) (see FIG. 7B). More specifically, the optically coupled semiconductor device 1 can be obtained in which the resin sealing portion 16 can be mounted on the mounting board 30 in parallel therewith, by preventing the outer contact faces Ss from being inclined with respect to the resin sealing portion 16.

It should be noted that this embodiment is more effective when applied to the U-shaped radiator 21 shown in Embodiment 3.

### Embodiment 5

An optically coupled semiconductor device according to Embodiment 5 of the present invention is described with reference to FIG. 8.

FIG. 8 is a side view of an optically coupled semiconductor device according to Embodiment 5 of the present invention. In FIG. 8, the optically coupled semiconductor device is mounted on the mounting board 30 of an electronic device (not shown).

In the U-shaped radiator 21 of the optically coupled semiconductor device 1 according to this embodiment, inward protrusions 22c are formed by bending the ends of the extended portions 22 inward, in the direction opposite to that in Embodiment 4. Since the inward protrusions 22c are formed by bending the ends of the extended portions 22, it is possible to completely prevent the U-shaped radiator 21 from falling off the resin sealing portion 16.

The inward protrusions 22c can be formed by forming the extended portions 22 long in advance and bending as appropriate the ends using a jig after the resin sealing portion 16 is inserted into the U-shaped radiator 21. The other configurations are the same as those in Embodiment 1, and thus a description thereof has been omitted as appropriate. With this configuration, the adhesive layer 24 can be made thin, and the adhesive layer 24 may be omitted if necessary. Thus, the processes can be simplified.

### Embodiment 6

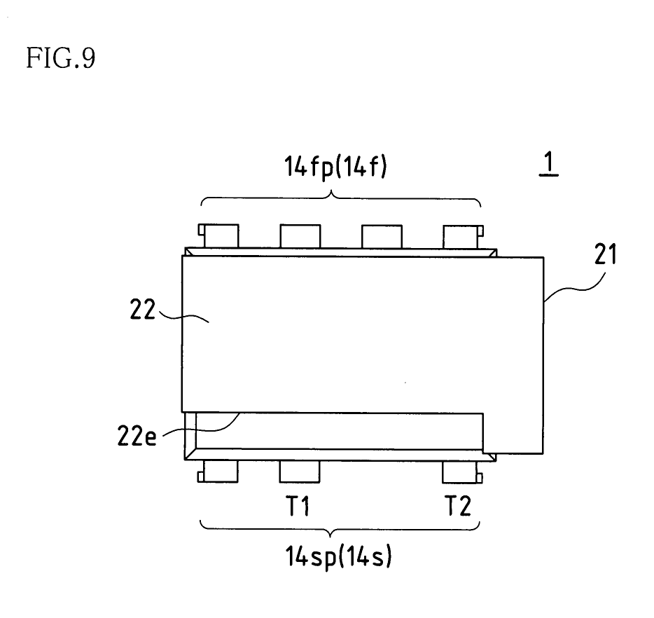

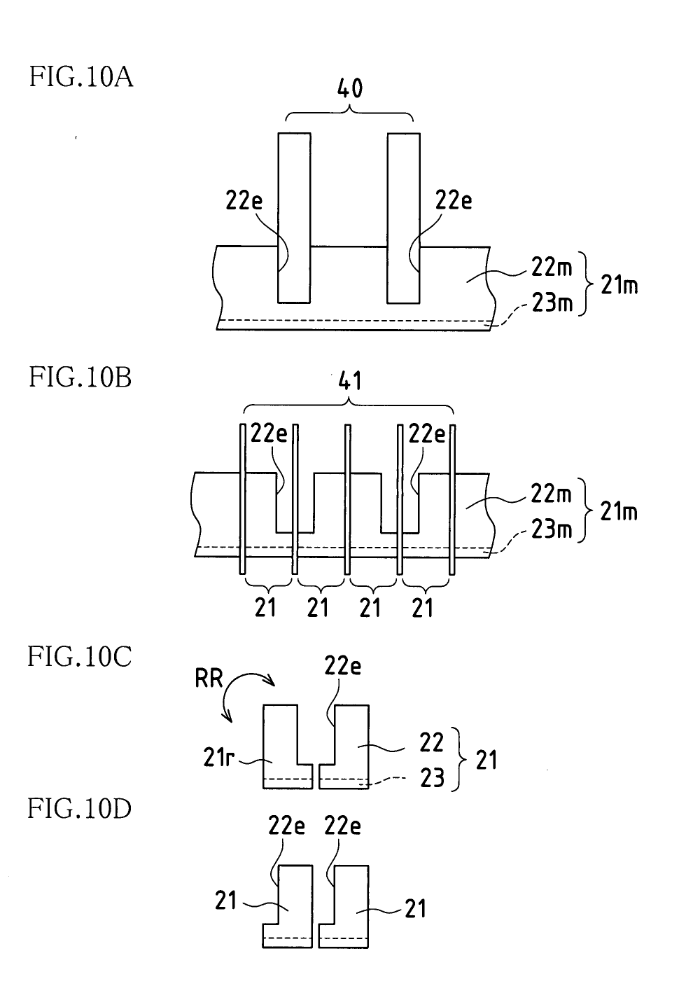

An optically coupled semiconductor device according to Embodiment 6 of the present invention is described with reference to FIGS. 9, 10A, 10B, 10C, and 10D.

FIG. 9 is a plan view of an optically coupled semiconductor device according to Embodiment 6 of the present invention.

Electrical Appliance and Material Safety Law, for example, prescribes the spacing (creepage distance) of the lead drawing portion 14sp, between the 8^{th} pin (the second output terminal T2) and the 6^{th} pin (the first output terminal T1) that are output terminals of the power control semiconductor element chip 11. In a case where the U-shaped radiator 21 is made of a metal such as aluminum, copper, and iron, the creepage distance between the 8^{th} pin and the 6^{th} pin is short. Thus, it is necessary to change the shape of the U-shaped radiator 21 in order to increase the creepage distance.

In the extended portions 22 of the U-shaped radiator 21 of the optically coupled semiconductor device 1 according to this embodiment, a cut-out portion 22e is formed by selectively removing a portion corresponding to the lead drawing portion 14sp that is drawn out of the resin sealing portion 16, thereby increasing the creepage distance between the 8^{th} pin and the 6^{th} pin.

With this configuration, it is possible to ensure the creepage distance for preventing electric discharge between the U-shaped radiator 21 and the lead drawing portion 14sp that is drawn out of the resin sealing portion 16, and thus the optically coupled semiconductor device 1 causing no electric discharge and thus having a high reliability can be obtained.

It should be noted that the shape of the cut-out portion 22e is shown only as an example, and any shape can be applied as long as it increases the creepage distance.

FIG. 10A is a process diagram illustrating a method for producing the U-shaped radiator for holding the resin sealing portion of the optically coupled semiconductor device according to Embodiment 6 of the present invention, the diagram being a plan view of a prepared long base material in a first cutting process. FIG. 10B is a plan view of the prepared long base material in a second cutting process. FIG. 10C is a plan view of symmetric U-shaped radiators obtained in the second cutting process. FIG. 10D is a plan view of a plurality of formed U-shaped radiators.

First, a long U-shaped radiator 21m as a base material that has been molded into a long shape is prepared. The long U-shaped radiator 21m is constituted by a long extended portion 22m corresponding to the extended portions 22 and a long linking portion 23m corresponding to the linking portion 23.

Next, as shown in FIG. 10A, regions corresponding to the cut-out portions 22e are cut and removed, with a first slicer 40 that is thick and can cut a predetermined area (first cutting process). After the first cutting process, as shown in FIG. 10B, regions corresponding to the U-shaped radiators 21 are cut, with a second slicer 41 that is thinner than the first slicer 40 and can cut the regions without wasting the area, and thus the U-shaped radiators 21 that have been symmetrically cut are formed (second cutting process).

FIG. 10C shows the symmetric U-shaped radiators 21 obtained in the second cutting process. When a symmetric U-shaped radiator 21r that has been formed symmetric to the U-shaped radiator 21 that has the original shape is turned over as indicated by the arrow RR (FIG. 10C), a plurality of U-shaped radiators 21 with the same shape can be simultaneously formed (FIG. 10D).

It should be noted that this embodiment can be applied to the other embodiments as appropriate.

### Embodiment 7

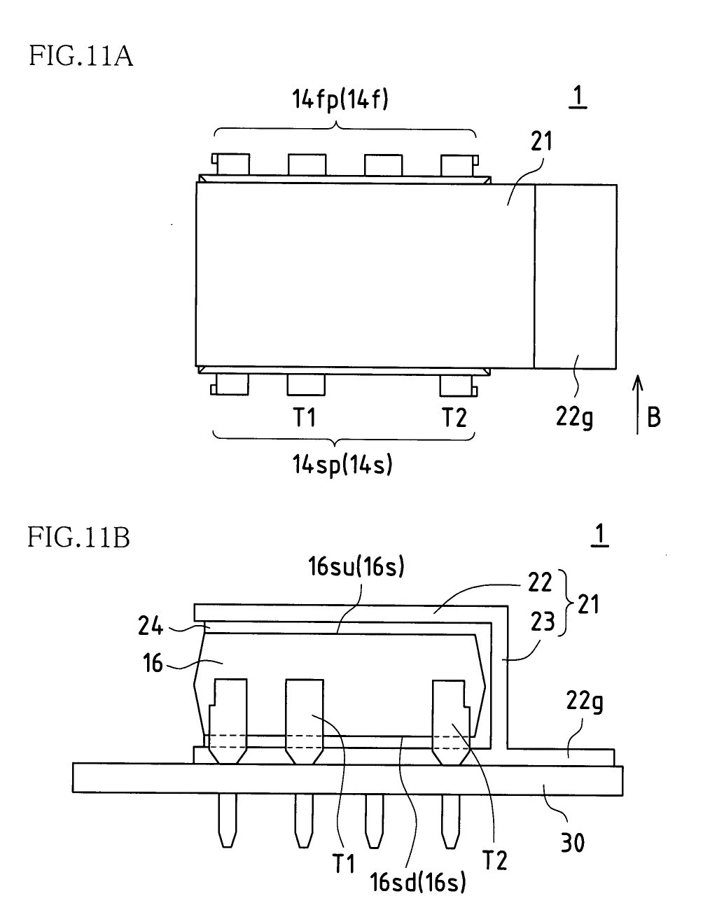

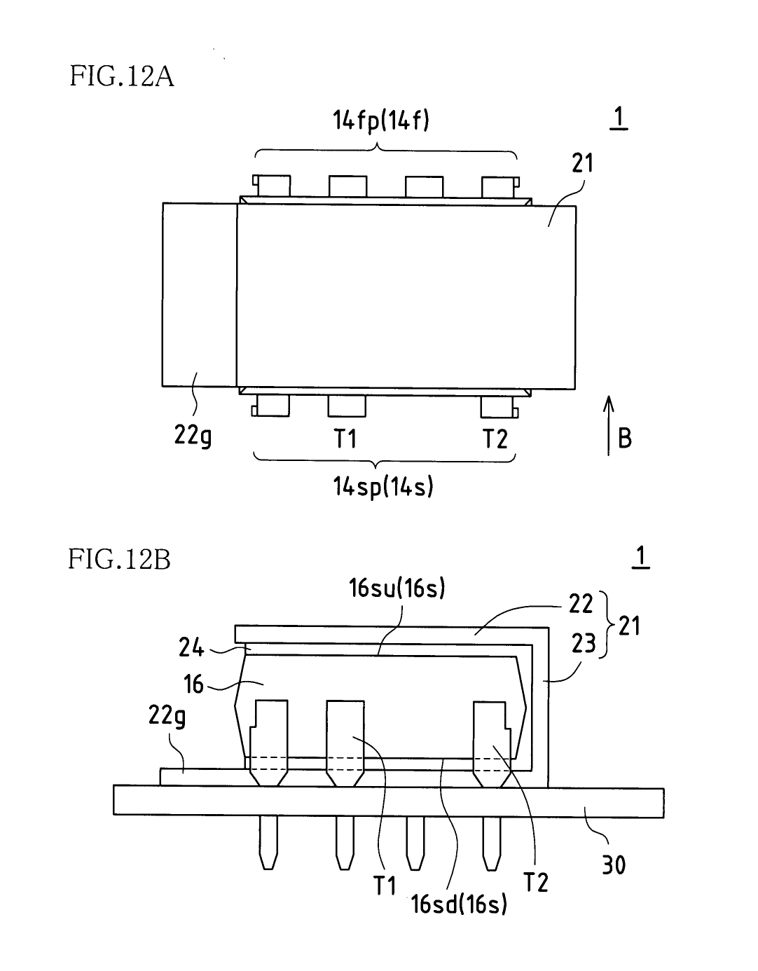

An optically coupled semiconductor device according to Embodiment 7 of the present invention is described with reference to FIGS. 11A, 11B, 12A, and 12B.

FIG. 11A is a plan view of an optically coupled semiconductor device according to Embodiment 7 of the present invention. FIG. 11B is a side view of FIG. 11A, viewed in the direction indicated by the arrow B. In FIG. 11B, the optically coupled semiconductor device is mounted on the mounting board 30 of an electronic device (not shown). FIG. 12A is a plan view of the optically coupled semiconductor device according to Embodiment 7 of the present invention. FIG. 12B is a side view of FIG. 12A, viewed in the direction indicated by the arrow B. In FIG. 12B, the optically coupled semiconductor device is mounted on the mounting board 30 of an electronic device (not shown).

In this embodiment, the extended portion 22 disposed closer to the mounting board 30 is formed longer than the other extended portion 22. With this configuration, the area abutting against the mounting board 30 can be increased, and thus the optically coupled semiconductor device 1 can be obtained in which the heat dissipation properties toward the mounting board 30 are improved.

In the optically coupled semiconductor device 1 shown in FIG. 11B, the extended portion 22 disposed closer to the mounting board 30 is provided with an additional extended portion 22g that extends outward from the linking portion 23. Accordingly, the extended portions 22 is substantially made longer, and the contact area with the mounting board 30 is increased, and thus the heat dissipation effect to the mounting board 30 can be improved.

In the optically coupled semiconductor device 1 shown in FIG. 12B, the extended portion 22 disposed closer to the mounting board 30 is provided with the additional extended portion 22g that extends outward from the end of the extended portion 22. Accordingly, the extended portions 22 is substantially made longer, and the contact area with the mounting board 30 is increased, and thus the heat dissipation effect to the mounting board 30 can be improved.

It is possible to further improve the heat dissipation effect by making the additional extended portion 22g as long as possible.

It should be noted that this embodiment can be applied to the other embodiments as appropriate.

### Embodiment 8

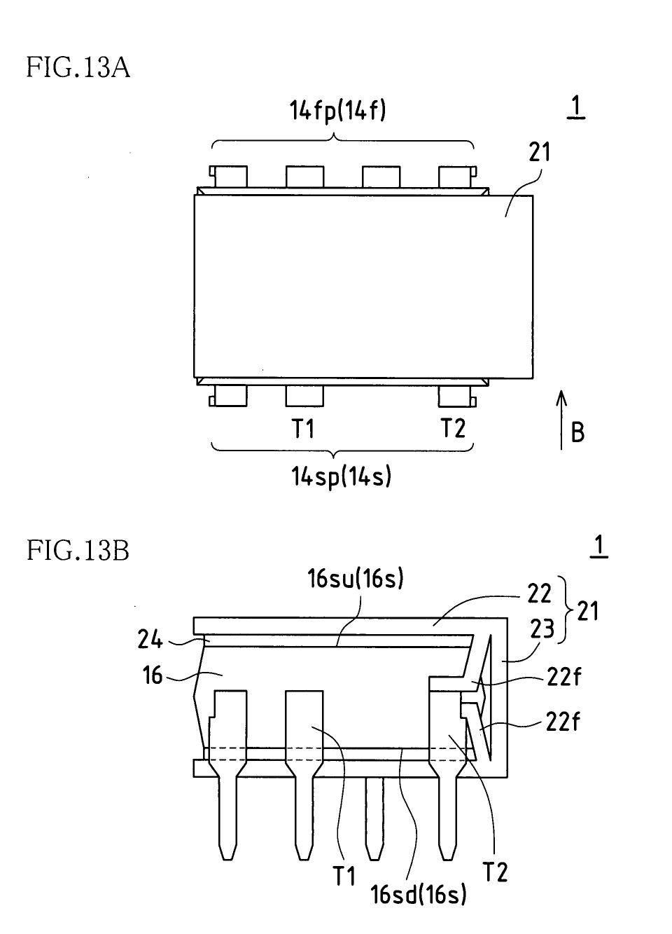

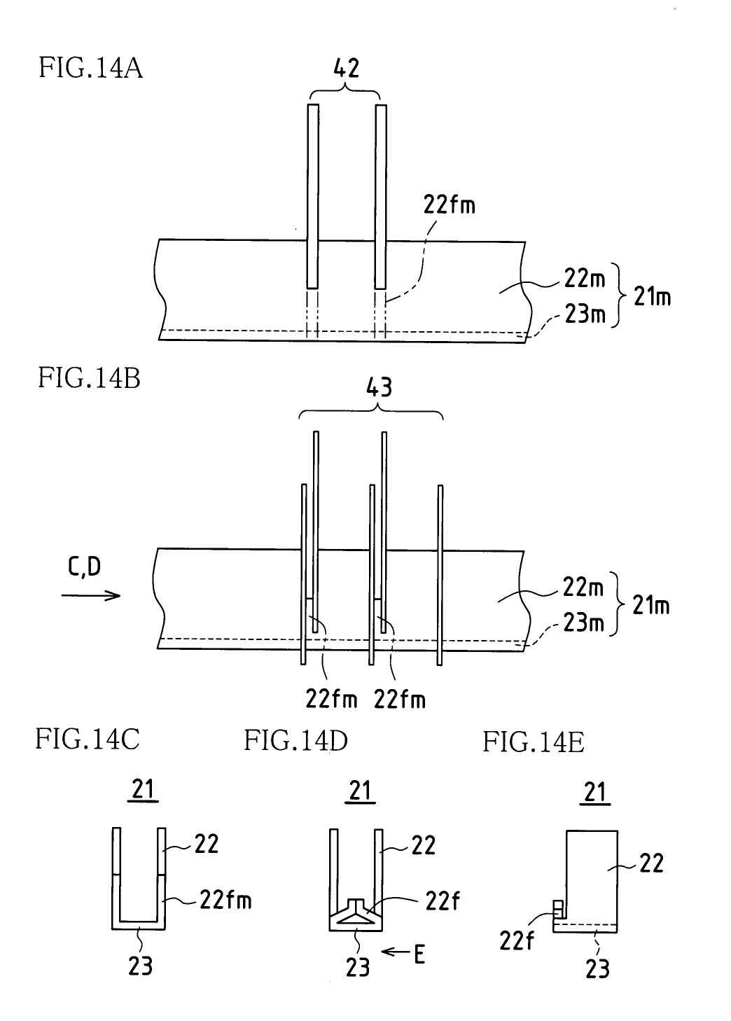

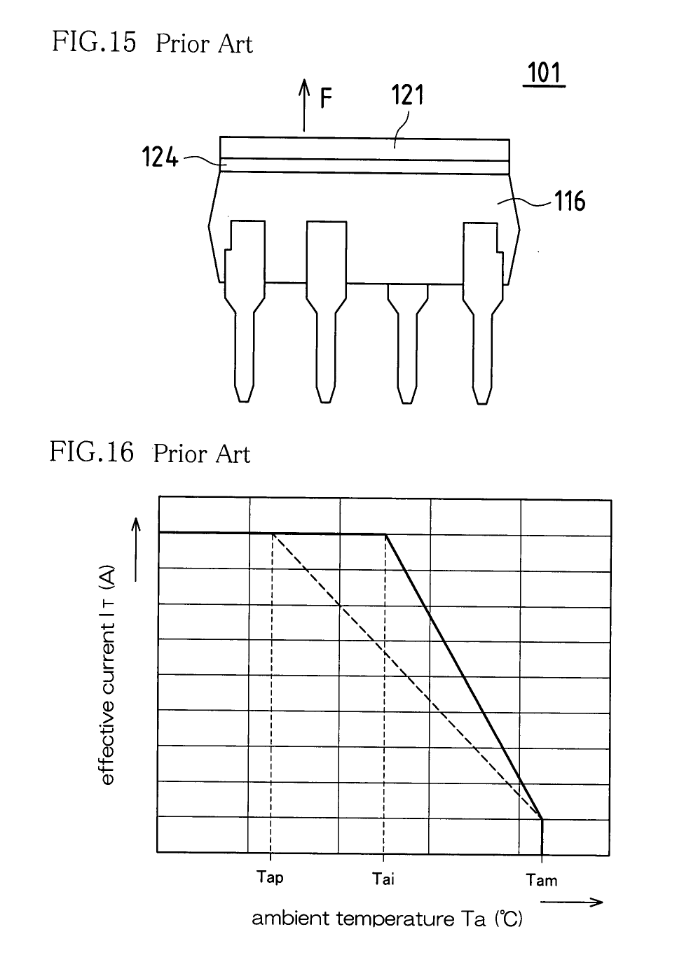

An optically coupled semiconductor device according to Embodiment 8 of the present invention is described with reference to FIGS. 13A, 13B, 14A, 14B, 14C, 14D, and 14E.

FIG. 13A is a plan view of an optically coupled semiconductor device according to Embodiment 8 of the present invention. FIG. 13B a side view of FIG. 13A, viewed in the direction indicated by the arrow B.

The lead drawing portion 14sp that is drawn out by extending the chip mounting portion 14sc on which the power control semiconductor element chip 11 is mounted is the 8^{th} pin (the second output terminal T2) of the output terminals. Since the power control semiconductor element chip 11 is mounted, the 8^{th} pin is a terminal having the largest amount of heat generated in the optically coupled semiconductor device 1. When the U-shaped radiator 21 is linked to the lead drawing portion 14sp (the 8^{th} pin) provided with the chip that particularly requires heat dissipation (the power control semiconductor element chip 11) in the lead drawing portion 14sp that is drawn out of the resin sealing portion 16, the heat dissipation properties are efficiently improved. Thus, the optically coupled semiconductor device with a high reliability can be obtained in which a large amount of electrical power can be supplied even at a high temperature.

Accordingly, the extended portions 22 of the U-shaped radiator 21 of this embodiment have holding portions 22f for selectively holding the lead drawing portion 14sp that is drawn out of the resin sealing portion 16. The holding portions 22f are formed by symmetrically bending the two opposed extended portions 22, and hold a selected portion corresponding to the 8^{th} pin that is drawn out of the resin sealing portion 16, from both the upper and lower faces thereof. The holding portions 22f can be easily formed by processing a part of the extended portions 22. Furthermore, the holding portions 22f also secure the lead drawing portion 14sp, and thus the securing strength (engagement strength) of the U-shaped radiator 21 can be further improved.

FIG. 14A is a process diagram illustrating a method for producing the U-shaped radiator for holding the resin sealing portion of the optically coupled semiconductor device according to Embodiment 8 of the present invention, the diagram being a plan view of a prepared long base material in a third cutting process. FIG. 14B is a plan view of the prepared long base material in a fourth cutting process. FIG. 14C is a side view of the U-shaped radiator obtained in the fourth cutting process. FIG. 14D is a side view of the U-shaped radiator on which the holding portions are formed. FIG. 14E is a plan view of the U-shaped radiator on which the holding portions are formed.

The long U-shaped radiator 21m is prepared as in FIGS. 10A to 10D. The long U-shaped radiator 21m has the same configuration as that in FIGS. 10A to 10D.

Next, as shown in FIG. 14A, unnecessary regions corresponding to holding preparing portions 22fm are cut and removed, with a third slicer 42 that can cut unnecessary regions of the long extended portion 22m corresponding to holding preparing portions 22fm (third cutting process). More specifically, in the third cutting process, the holding preparing portions 22fm for forming the holding portions 22f are formed.

After the third cutting process, as shown in FIG. 14B, regions corresponding to the U-shaped radiators 21 are cut, with a fourth slicer 43 that is thinner than the third slicer 42 and can cut the regions without wasting the area, and thus the U-shaped radiators 21 that have been cut are formed (fourth cutting process).

FIG. 14C is a side view of the U-shaped radiator 21 obtained in the fourth cutting process, viewed in the direction indicated by the arrow C, D in FIG. 14B. It is shown that the holding preparing portions 22fm are formed on the same plane as the extended portions 22. By bending the holding preparing portions 22fm in FIG. 14C using an appropriate jig (mold), the U-shaped radiator 21 having the holding portions 22f are formed (FIG. 14D). FIG. 14E is a plan view of the U-shaped radiator 21, viewed in the direction indicated by the arrow E in FIG. 14D. Since the ends of the holding portions 22f serve as guiding members by being bent outward as appropriate, failures in the production processes can be reduced, and thus the production efficiency can be improved.

### Embodiment 9

The optically coupled semiconductor device 1 according to Embodiments 1 to 8 can be mounted on the mounting board 30 provided on an electronic device. More specifically, embodiments other than those in FIGS. 2B, 3B, 4B, 8, 11B, or 12B can be similarly applied to the mounting board 30 provided on an electronic device. With this configuration, the electronic device can be obtained that is provided with the optically coupled semiconductor device 1 having excellent heat dissipation properties, and thus the electronic device having good heat dissipation properties and a high reliability can be obtained.

When heat dissipation to the mounting board 30 is ensured by bringing the extended portion 22 disposed closer to the mounting board 30 into contact with the mounting board 30, heat is conducted directly from the U-shaped radiator 21 to the mounting board 30 without passing through space, so that the thermal resistance Rth (j-a) of the resin sealing portion 16 is reliably reduced. Thus, the electronic device having better heat dissipation properties and a higher reliability can be obtained.

The properties of the optically coupled semiconductor device 1 according to Embodiments 1 to 9 are indicated by the solid line in FIG. 16.

More specifically, the optically coupled semiconductor device 1 according to the present invention can make a temperature Tai at which a decrease in the effective current IT starts higher than the conventional temperature Tap. Thus, in the optically coupled semiconductor device 1 according to the present invention, the effective current at a higher temperature can be increased more than conventional examples, and a large amount of electrical power can be controlled.

The present invention can be embodied and practiced in other different forms without departing from the gist and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. An optically coupled semiconductor device that is provided with a resin sealing portion and lead drawing portions, the resin sealing portion integrally sealing a power control semiconductor element chip, an firing light-receiving element chip for firing the power control semiconductor element chip, and a light-emitting element chip optically coupled with the firing light-receiving element, for converting an electric signal into an optical signal, and the lead drawing portions being connected to the power control semiconductor element chip, the firing light-receiving element, and the light-emitting element chip, and being drawn out of the resin sealing portion, comprising:
a U-shaped radiator having extended portions that extend in an extending direction intersecting a drawing direction of the lead drawing portions and that are operable to hold the resin sealing portion therebetween.

2. The optically coupled semiconductor device according to claim 1,
wherein a groove portion is formed on an inner face of the extended portions.

3. The optically coupled semiconductor device according to claim 2,
wherein the groove portion is formed in a direction intersecting the extending direction.

4. The optically coupled semiconductor device according to claim 1,
wherein outward protrusions are formed by bending ends of the extended portions outward.

5. The optically coupled semiconductor device according to claim 1,
wherein the extended portions are formed such that an opposing distance therebetween is short on the side of ends.

6. The optically coupled semiconductor device according to claim 4,
wherein the outward protrusions are formed such that outer contact faces defined by the extended portions and the outward protrusions are in parallel with the resin sealing portion.

7. The optically coupled semiconductor device according to claim 1,
wherein inward protrusions are formed by bending ends of the extended portions inward.

8. The optically coupled semiconductor device according to claim 1,
wherein a linking portion for linking between the extended portions is bent.

9. The optically coupled semiconductor device according to claim 1,
wherein the extended portions have a cut-out portion formed by selectively removing a portion corresponding to the lead drawing portion that is drawn out of the resin sealing portion.

10. The optically coupled semiconductor device according to claim 1,
wherein the extended portions have holding portions for selectively holding the lead drawing portion that is drawn out of the resin sealing portion.

11. The optically coupled semiconductor device according to claim 10,
wherein the holding portions hold therebetween a lead drawing portion of a lead frame on which the power control semiconductor element chip is mounted.

12. The optically coupled semiconductor device according to claim 1,
wherein the extended portion disposed closer to a mounting board is longer than the other extended portion.

13. An electronic device in which an optically coupled semiconductor device is mounted on a mounting board,
wherein the optically coupled semiconductor device is the optically coupled semiconductor device according to claim 1.

14. The electronic device according to claim 13,
wherein the extended portion disposed closer to the mounting board is in contact with the mounting board.
